(19) United States
(12) Patent Application Publication
(10) Pub. No.: US 2007/0100540 A1
(43) Pub. Date: May 3, 2007

(54) System and method for managing signage and wayfinding elements

(76) Inventors: Steven L. Stamper, Austin, TX (US); Gregory V. Giordano, Austin, TX (US); Gale Brundrett III, Alexandria, VA (US); Jon E. Freach, Austin, TX (US); Stephanie L. Holt, Austin, TX (US); Beverly S. Poore, Dripping Springs, TX (US)

Correspondence Address: JACKSON WALKER LLP, 901 MAIN STREET, SUITE 6000, DALLAS, TX, 75202-3797, US

(21) Appl. No.: 11/591,782

(22) Filed: Nov. 2, 2006

Related U.S. Application Data
(60) Provisional application No. 60/732,506, filed on Nov. 2, 2005.

(51) Int. Cl. G01C 21/30

(52) U.S. Cl. 701/202; 701/209; 340/995.19

(57) ABSTRACT

A system for organizing, editing, and processing signage and other wayfinding elements in response to relocations, expansions, renovations, and standard maintenance is provided. At the core of the system is a structured database that holds all the wayfinding logic and content for a facility. A user can manage multiple and overlapping projects paralleled with construction schedules. Computer-aided Design (CAD) files can-be linked to the system and wayfinding information overlaid on the plans. The user can generate timelines, message schedules, work orders, sign location plans, and through automated scripts, generate Encapsulated PostScript (EPS) files for sign production. After installation, the user can field-verify signs by generating fieldbooks from the system. The present invention also communicates accurate and useful wayfinding information, such as point-to-point directions, to visitors to the facility.

### PRIORITY CLAIM

This application claims priority of U.S. Provisional Ser. No. 60/732,506, entitled “SIGNAGE AND COMMUNICATIONS MANAGEMENT SYSTEM” filed Nov. 2, 2005, incorporated herein by reference.

### FIELD OF THE INVENTION

The present invention generally related to software management systems, and more specifically to signage and wayfinding management software systems.

### BACKGROUND OF THE INVENTION

Large facilities such as corporate and academic campuses, convention centers, and healthcare institutions do not currently have a systematic and centralized way of managing their signage systems and other wayfinding devices such as maps and websites. Space needs change frequently, triggering a constant succession of relocations, expansions, and renovations. Signage must be updated in tandem with changes in the environment, not only to direct people to locations, but also to comply with regulatory and safety requirements.

Today, facilities managers organize these tasks with the aid of traditional and disconnected tools such as architectural plans, spreadsheets of affected signage, schedules of moves, and sign templates. Because the information is decentralized, errors can be introduced easily. Without dedicated oversight, signage systems can lose their integrity quickly, resulting in a lost people and code noncompliance.

For complex facilities that have a larger percentage of first time visitors (such as academic campuses, convention centers, and healthcare institutions), it is important to provide wayfinding information in multiple forms such as: a website for trip planning and finding directions to specific locations, maps and visitors' guides, and onsite touch-screens to print point-to-point directions. These additional tools compound the problem of keeping the information accurate as the facility evolves. To add to the complexity, these communication vehicles are often generated and maintained by different departments, making consistency and accuracy even more difficult to achieve. The process of wayfinding programming and signage installation is not always a strict linear workflow, and involves multiple iterations and approval cycles.

### SUMMARY OF INVENTION

In accordance with the present invention, a system and method for managing signage and wayfinding elements are presented that overcome known problems with managing signage and wayfinding elements. The present invention achieves technical advantages as a system for organizing, editing, and processing signage and other wayfinding elements in response to relocations, expansions, renovations, and standard maintenance. The present invention also achieves advantages in communicating accurate and useful wayfinding information, such as point-to-point directions to visitors to the facility. One exemplary embodiment of the invention utilizes a structured database that holds all the wayfinding logic and content for a facility. A user can manage multiple and overlapping projects paralleled with construction schedules. Computer-aided Design (CAD) files can be linked to the system and wayfinding information overlaid on the plans. The user can generate timelines, message schedules, work orders, sign location plans, and through automated scripts, generate Encapsulated PostScript (EPS) files for sign production. After installation, the user can field-verify signs by generating punchlists from the system.

### BRIEF DESCRIPTION OF THE DRAWINGS

FIG. 1 is a diagram of a system for signage and wayfinding management in accordance with an exemplary embodiment of the present invention;

FIG. 1A is a diagram of a system for relational wayfinding in accordance with an exemplary embodiment of the present invention;

FIG. 2 is a diagram of a wayfinding method in accordance with an exemplary embodiment of the present invention;

FIG. 3 is a diagram of a relational wayfinding route generation and validation method in accordance with an exemplary embodiment of the present invention;

FIG. 4 is a diagram of a method for zone of ownership hierarchy construction in accordance with an exemplary embodiment of the present invention;

FIG. 5 is a diagram of a signage generation method in accordance with an exemplary embodiment of the present invention; and

FIG. 6 is a diagram of a signage management method in accordance with an exemplary embodiment of the present invention.

### DETAILED DESCRIPTION OF THE PRESENT INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

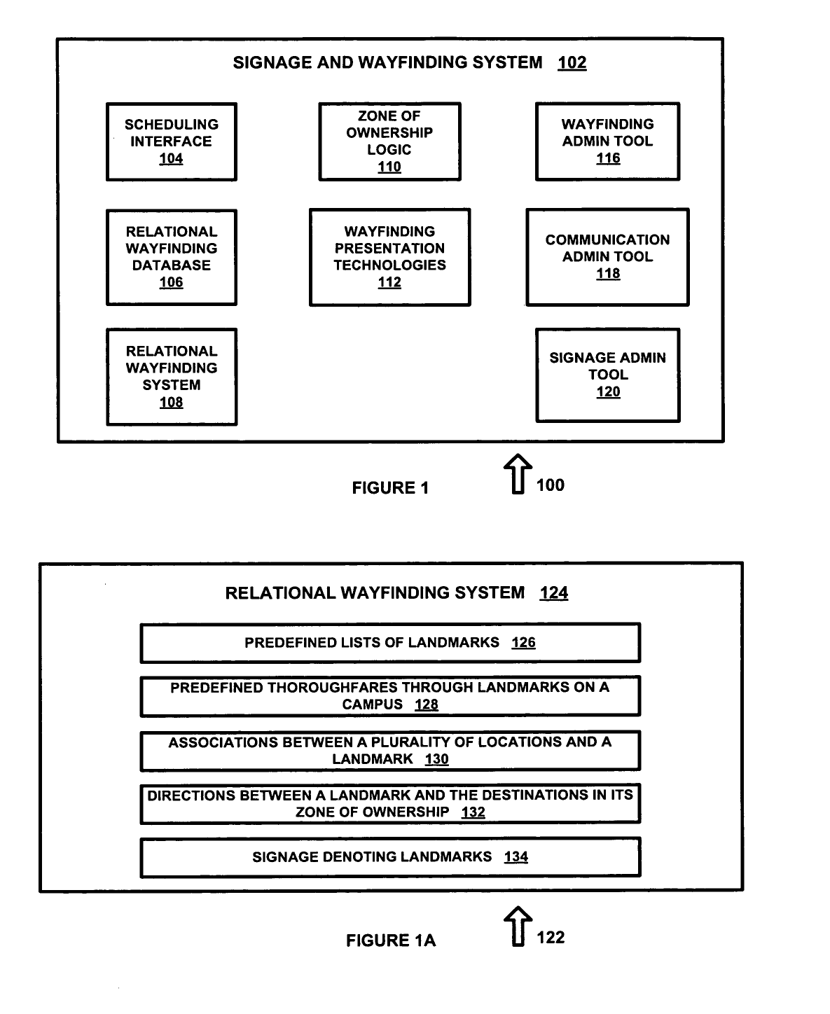

Referring to FIG. 1, there is shown a diagram of a system 100 for signage and wayfinding management in accordance with an exemplary embodiment of the present invention. System 100 allows signage and wayfinding management to be performed such as where signage or wayfinding is generated or modified. System 100 includes signage and wayfinding management 102 which is further comprised by scheduling interface 104 relational wayfinding database 106, relational wayfinding logic 108, zone of ownership logic 110, wayfinding presentation technologies 112, wayfinding admin tool 116, communication admin tool 118, and signage admin tool 120. Each of which could be implemented in hardware, software or a suitable combination of hardware and software and which could be one or more software systems upgrading on a general purpose processing platform.

As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Scheduling interface 104 generates task lists appropriate to any given change to wayfinding data. In one exemplary embodiment a new destination may be added to the wayfinding system in which case a task list detailing each step would be generated by the scheduling interface 104 for placement of newly create signage at the appropriate landmark.

Relational wayfinding database 106 allows all wayfinding data to be managed in one centralized database. In one exemplary embodiment, relational wayfinding database 106 may store the official names of buildings, parking garages, room numbers, destinations, or numbered entries. Additionally, it may store the main entrance to every destination, data distinctions between public, staff, and restricted destinations and pointers to accurate, as-built, CAD drawings of the entire facility. The application is designed to integrate with Oracle 9i which was the enterprise standard database platform at the time development was undertaken.

Relational wayfinding system 108 allows for the generation of directions through landmarks from an origination to a destination. In one exemplary embodiment, landmarks are defined within a facility and connected to form main thoroughfares through the facility. These landmarks and thoroughfares are the basis for all direction generation and at the core of the wayfinding logic. The system also keeps track of geographic planes, or floor designations. Each landmark and thoroughfare segment is assigned attributes that are later used to calculate the best route. Thoroughfare segments can be any travel route, whether shuttle buses, sky bridges, or interior corridors. These thoroughfares are manually defined during system setup, and dynamically referenced thereafter. When a route is calculated dynamically, there are a series of rules that are utilized to calculate that route.

One rule is to look for the shortest route (since all thoroughfare segments have static length). In one exemplary embodiment, another rule is to keep the user on the level (geographic plane) they are on for as long as possible, so if they have to go up or down in an elevator, it is near the end of their journey. This is helpful because elevators are landmarks and it is likely that their destination is in the zone of ownership of the elevator. So, getting them to the right elevator on the right floor gets them very near to their destination.

Zone of ownership logic 110 allows for new destinations proximate to a landmark to be assigned to said landmark. This is done to minimize the calculation of directions to a destination. In one exemplary embodiment a new destination is added to the facility and the destination is assigned to an elevator landmark, putting it in the elevator landmark's zone of ownership (ZOO). This minimizes the wayfinding logic because each landmark is on a major thoroughfare, so the last leg of direction generation that needs to be calculated is from the landmark to the destination. Additionally, the signage at the landmark will be changed to reflect the new destination.

Wayfinding presentation technologies 112 allows for managing the data and graphical assets used to provide wayfinding information to users. In one exemplary embodiment, a touch screen kiosk is placed in the front lobby of a facility. The graphical assets used in the kiosk are managed by the wayfinding presentation technologies 112. Advantageously, driving directions may be edited and temporary changes to asset availability may be made. This ties into the overall scheduling functionality and provides automated interfaces for updates in order to handle large changes such as building additions. Temporary and permanent changes to wayfinding elements such as directions and elevator closures can be managed in this tool.

Wayfinding admin tool 116 allows management of wayfinding data. In one exemplary embodiment, the tool allows a user to define and manage projects, checklists, tasks, and associated CAD files. Advantageously, the user may define and manage assets including destinations, landmarks, pathways, driving directions, and parking facilities. In one exemplary embodiment, a hallway may be closed due to maintenance and an alternate route must be determined around the closure. The wayfinding admin tool would allow a user to generate said path around the closure and have it available near real-time for end users of the system. Additionally, wayfinding admin tool 116 allows for a sign location plan to be generated as well as a destination diagram interface to be rendered. Data versioning, defined as data management for overlapping projects, is also possible.

Communication admin tool 118 allows for the preparation of reports that generate a list of all changes made to destinations, landmarks, and other objects within a given date range. The functionality of the communication admin tool 118 includes generation of reports and alerts for changes made to the wayfinding system to guide updates of maps and other printed collateral. In one exemplary embodiment, the communication admin tool 118 is used to generate a report on kiosk usage after a change has been made to a route.

Signage admin tool 120 allows management of signage assets and data. This tool provides finctionality for relating data changes directly to specific sites. The system provides automated updating of graphic files, and packaging of those files with work orders, to be sent to the sign shop or fabrication facility for fulfillment. The functionality includes searching and sorting signs by package, printing message schedules, creating and managing signs, sign types and icons, overseeing art production and improvement of art files, and managing a library of fabricators. While some changes to signage are triggered by destination name changes or enhancements to wayfinding logic, the majority of changes are caused by relocations or expansion, additions to the facility, and the associated back filling.

In one exemplary embodiment, a user can manage multiple and overlapping projects that affect signage. By selecting areas on the floor plan a user can move a destination from its current location to another location. The system will automatically flag all affected signs. Each move is designated as a project with a target end date so that the resulting state of an earlier project is incorporated into the next project. The affected signs for a given project can be organized into multiple packages. In one exemplary embodiment, exterior signs may go to a fabricator while interior signs may go to an in-house sign shop. A facility manager will create a project and enter the target end date, make the required changes on the relevant floor plan, create a package of exterior signs in order to receive bids from fabricators while the sign shop will generate the interior signs. A punchlist, also known as a fieldbook, will be printed out for installation verification and reports will be generated to provide all changes to the graphics department to update all maps, visitor's guides, and the website.

In operation system 100 allows signage and wayfinding elements to be managed and maintained through one centralized application. In this manner, space is programmed using a series of diagrams including destination diagrams, landmark zone of ownership diagrams, and sign location plans. In one exemplary embodiment, these diagrams are created in AutoCAD using a plug-in that ties the appropriate data back to the relational wayfinding database 106. Signage message schedules are automatically populated by scheduling interface 104 based on information contained in these diagrams. Any additional data or assets required for the kiosk and website are entered through the wayfinding admin tool 116 and rendered through the wayfinding presentation technologies 112.

Signage production and installation is managed through the signage admin tool 120 and approved by the scheduling interface 104. At any time in the process, the system can be tested. This will run through a series of automated checks looking for errors in wayfinding logic or data associations. Some of the same tests are performed automatically before signage export is allowed to occur and a project cannot be launched until all tests are passed. Advantageously, the user can manage multiple and overlapping projects in parallel with construction schedules through the use of the inheritance in versioning concept by giving the projects a launch and end date. The end user can then acquire detailed directions to the area in the facility that they need to visit. The directions are generated by the relational wayfinding logic 108 which refers to the relational wayfinding database 106 for all elements required to render the directions given the zone of ownership logic 110 to the end user through the wayfinding presentation technologies 112.

FIG. 1A is a diagram of a system 122 for relational wayfinding in accordance with an exemplary embodiment of the present invention. System 122 allows relational wayfinding to be performed such as where wayfinding elements are utilized to provide direction to a user. System 122 includes relational wayfinding system 124 which is further comprised by predefined lists of landmarks 126, predefined thoroughfares through landmarks on a campus 128, associations between a plurality of locations and a landmark 130, directions between a landmark and the destination in its ZOO 132, signage denoting landmarks 134.

Predefined lists of landmarks 126 allows for the definition and assignment of landmarks on a campus. In one exemplary embodiment, landmarks are defined in an automotive plant.

Predefined thoroughfares through landmarks on a campus 128 allows for the definition and assignment of pathways through each of the landmarks on a campus. In one exemplary embodiment, thoroughfares through landmarks are defined in a grain warehouse.

Associations between a plurality of locations and a landmark 130 allows for the definition and assignment of destinations to landmarks on a campus. In one exemplary embodiment, three destinations are associated to a directory landmark in a mall.

Directions between a landmark and the destination in its ZOO 132 allows for the definition and assignment of directions between a landmark and one of its destinations on a campus. In one exemplary embodiment, directions from an elevator to a media room are defined in a building.

Signage denoting landmarks 134 allows for the labeling of landmarks on a campus. In one exemplary embodiment, the admissions desk at a hospital has a sign labeled “Admissions” showing all of the destinations in its zoo.

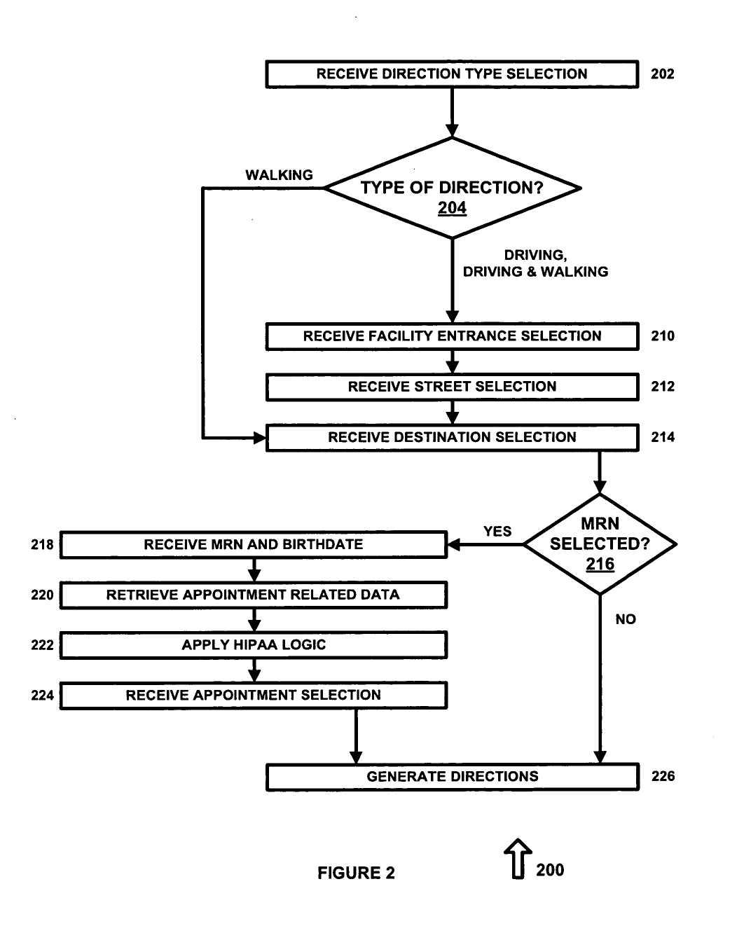

FIG. 2 is a diagram of a method 200 for generating directions for a user. Method 200 allows for initial conditions to be selected by a user for direction determination. Method 200 begins at 202 where the method receives the direction type selection from the user. In one exemplary embodiment, a user requiring directions to a destination accesses the website for the facility and selects the type of directions they require. The user selects walking directions, driving directions, or walking and driving directions. The method then proceeds to 204.

At 204, there is shown a logic block which routes the user to the next step in generating directions which satisfy the user's requirements. In one exemplary embodiment, the user selects walking directions, at which point the type of direction decision block 204 routes the user to the next requirement for the selected direction generation, select the destination at the facility. In another exemplary embodiment, the user selects either driving directions or driving and walking directions, both of which result in the user being prompted to enter how they would prefer to enter the building. The method then proceeds to 210.

At 210, the method receives the user's selection of how they prefer to enter the building. In one exemplary embodiment, this will be a parking garage. The method then proceeds to 212.

At 212, the method receives the street or highway that the user has selected to enter the campus. In one preferred embodiment, the origination is Interstate 10 traveling east. The method then proceeds to 214.

At 214, the method receives the destination selection. At this point, the direction type whether walking, driving, and driving and walking, all require the selection of a destination. Destination options include a user's medical record number (MRN), a clinic department or room name, a building name, a landmark, a room number, and food, shops or services. In one exemplary embodiment, the destination option chosen is the user's MRN. The method then proceeds to 216.

At 216, there is shown an MRN selected decision block which sends the user on to MRN-related steps if the destination selection was “Enter Your MRN.” The method then proceeds to 218. If anything other than the MRN option was selected, the location code associated with the destination is stored and the method then proceeds to 226.

At 218, the method receives the MRN and birthdate from the user input. The method then proceeds to 220.

At 220, the method retrieves the appointment related data associated with the medical record number and the birthdate. If the medical record number and the birthdate do not match or are invalid, an error is displayed. The method then proceeds to 222.

At 222, Health Insurance Portability and Accountability Act (HIPAA) related filter logic is applied to the data. In one exemplary embodiment, a flag is used to denote whether an appointment is private or public. If the appointment is private then an error is displayed and the appointment data is not rendered. If the appointment related data is not flagged and is public then the appointments for the MRN and birthdate are displayed to the user. The method then proceeds to 224.

At 224, the method receives the appointment selection from the user. In one exemplary embodiment, the user has three appointments to choose from and selects a medical imaging appointment. The method then proceeds to 226.

At 226, the method then generates directions satisfying all selection requirements given by the user. In one exemplary embodiment, driving and walking directions, estimated travel times, a driving map with landmarks along the route, and a walking map with landmarks along the route are displayed to the user.

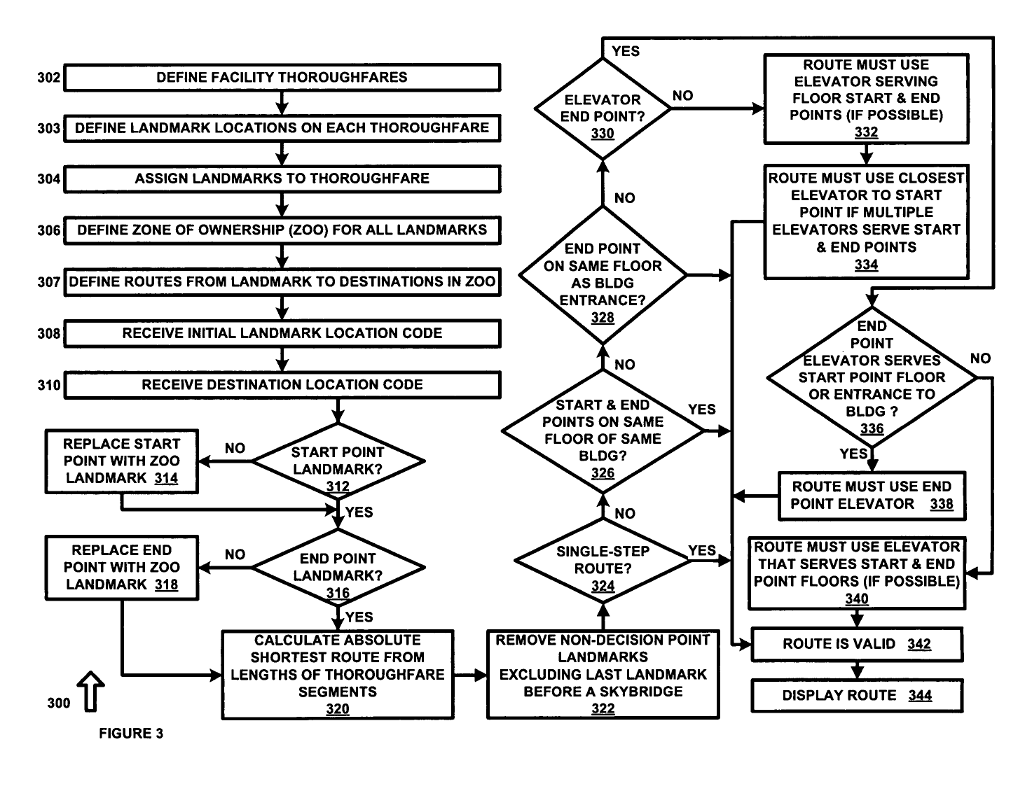

FIG. 3 is a diagram of a method 300 for relational wayfinding route generation and validation in accordance with an exemplary embodiment of the present invention. The relational wayfinding method makes direct use of only two classes of objects: landmarks and thoroughfare segments. Landmarks include architectural landmarks and elevator exits, as well as a small set of “invisible” landmarks such as that which allows wayfinding in an otherwise landmark-free environment. Thoroughfare, or pathway, segments join landmarks, including both explicitly defined and measured segments (e.g., Elevator A exit to Children's Center, 180 feet), dynamically-defined connections between all the exits in each elevator bank, and skybridges. All other entities used as starting and ending points for wayfinding trips (destinations, amenities, garages and valets, events, etc.) are directly or indirectly linked to a landmark, so the relational wayfinding logic remains landmark-to-landmark even when neither the starting point nor the end point is defined as a landmark.

Method 300 begins at 302 where facility thoroughfares are defined. In one exemplary embodiment, facilities thoroughfares are defined by receiving one or more user data selections from a map, or in other suitable manners. The method then proceeds to 302.

At 303 landmark locations are defined on each thoroughfare. In one exemplary embodiment, landmark locations can be retrieved from map coordinate locations that are within a predetermined distance to a predefined facility thoroughfare, can be added by user, or can be created in other suitable manners. The method then proceeds to 304.

At 304, landmarks are assigned to the thoroughfare. In one exemplary embodiment, the landmarks are assigned to a thoroughfare after landmark definition, manually, in other suitable manners, the method then proceeds to 306.

At 306, a Zone Of Ownership (ZOO) is defined for each landmark. In one exemplary embodiment, the ZOO can be a predetermined radius around a landmark, can be defined by a user, or it can otherwise be assigned. The method then proceeds to 307.

At 307, routes from each landmark to all destinations in its ZOO are defined. In one exemplary embodiment, directions from a water fountain landmark to each of the five destinations in its ZOO are defined. The method then proceeds to 308.

At 308, the initial, or origination, landmark location code is received. In one exemplary embodiment, the landmark location code can be automatically assigned based on the location within predetermined or predefined CAD drawing codes, can be received from a user selection on a menu, can be edited manually by a user, or can otherwise be input by a user. The method then proceeds to 310.

At 310, destination location codes are received. In one exemplary embodiment, destination locations codes can be manually input, selected from a pull down menu, automatically assigned based on CAD drawing data, or otherwise provided. The method then proceeds to 312.

At 312, there is shown a start point landmark decision block. The method proceeds to 314 if the start point is not a landmark. The method proceeds to 316 if the start point is a landmark.

At 314, a starting point is replaced with the landmark in the ZOO. In one exemplary embodiment, the starting point is replaced with a landmark owning the ZOO in which the destination resides so route calculation can be initiated through thoroughfares to the landmark. Start point landmarks can be entrances and exits into and from a facility's commonly visited buildings, rooms within a facility, or other suitable landmarks. The method then proceeds to 316.

At 316, there is shown an end point decision block. The method proceeds to 318 if the end point is not a landmark. The method proceeds to 320 if the end point is a landmark.

At 318, an ending point is replaced with the landmark owning the ZOO in which the destination resides. In one exemplary embodiment, the ending point is replaced with a landmark owning the ZOO in which the destination resides so route calculation can be initiated through thoroughfares to the landmark. End point landmarks can be entrances and exits into and from a facility's commonly visited buildings, rooms within a facility, or other suitable landmarks. The method then proceeds to 320.

At 320, the absolute shortest route is calculated with the thoroughfare segment lengths. This yields an initial list of landmarks. In one exemplary embodiment, the distances calculated at 320 can be sorted such that the shortest route distance can be the default route. Likewise, backup routes can be stored to accommodate construction, route blockage or other suitable contingencies. the total distances between the end landmarks are calculated for a predetermined number of routes, such as all routes. The distances between landmarks for all routes can be calculated with an AutoCAD plug-in, manually entered, or can otherwise be provided. The method then proceeds to 322.

At 322, landmarks that are not decision points are removed from the route generation, unless the landmark is the last landmark before a skybridge. In one exemplary embodiment, the list is winnowed to remove landmarks that do not represent decision points for the user. All elevator stops between the entrance and exit floors of an elevator trip are removed. The system also removes any landmarks that appear between two other landmarks on the same floor, because they are not decision points for the traveler. The only exception to this rule is made for the landmark before a Skybridge entrance, which represents an important point in the directions the system generates for the user. At this point, the method has generated a path representing all the decision points for the shortest-possible distance between the start and end landmarks. The route is then examined to determine its validity according to the business rules that govern the wayfinding method. The method then proceeds to 324.

At 324, there is shown a single-step decision block. The method proceeds to 342 if the route is a single-step route. In one exemplary embodiment, a single-step route is defined as landmark-segment-landmark. The method proceeds to 326 if the route is not a single-step route.

At 326, there is shown a start and end points on same floor of same building decision block. The method proceeds to 342 if the start and end points are on the same floor of the same building. The method proceeds to 328 if the start and end points are not on the same floor of the same building.

At 328, there is shown an end point on same floor as building entrance decision block. The method proceeds to 342 if the end point is on the same floor as building entrance. The method proceeds to 330 if the end point is not on the same floor as building entrance.

At 330, there is shown an elevator end point decision block. The method proceeds to 336 if the end point landmark is an elevator. The method proceeds to 332 if the end point landmark is not an elevator.

At 332, the elevator is not an end point, so the route generation an validation method must use an elevator that serves start point floor and end point floor, if one exists. In one exemplary embodiment, an elevator bank with a plurality of elevators serves multiple floors. Only one of the elevators in the elevator bank serves the start point floor and the end point floor. Therefore, the elevator serving the start and end point floors is selected and the others bypassed. The method then proceeds to 334.

At 334, if multiple elevators serve the start and end point floors, the elevator closest to the start point is selected and the others bypassed. The method then proceeds to 342.

At 336, there is shown an end point elevator serves start point floor or entrance to building decision block. The method proceeds to 338 if the end point elevator serves the start point floor or an entrance to a building. The method proceeds to 340 if the end point elevator does not serve the start point floor or an entrance to a building.

At 338, the route generation an validation method must use the end point elevator. In one exemplary embodiment, a plurality of elevators exist and the elevator which is the end point is selected. The method then proceeds to 342.

At 340, the route must use an elevator that serves the start and end point floors if possible. In one exemplary embodiment, the end point elevator does not serve the start point floor or entrance. So, the route generation selects an elevator that serves the start and end point floors, if possible, and then continues to the end point elevator. The method then proceeds to 342.

At 342, the route generated from the start point to the end point is valid. The method then proceeds to 344.

At 344, the shortest valid route through landmarks to a destination is displayed. In one exemplary embodiment, a user can enter a start or origination landmark, a destination landmark, and can request directions from the origination landmark to the destination landmark. All pathways returned by the relational wayfinding method 300 include a neighborhood map associated with the start landmark. If the decision point path contains more than one landmark, the building map associated with the first landmark is added to the pathway. If the directions span multiple buildings, a campus map is added to the pathway (or not, if the decision to not show campus maps remains in effect). The pathway's set of maps concludes with the building map associated with the final landmark on the path. Text directions and estimated travel times for each segment are also displayed.

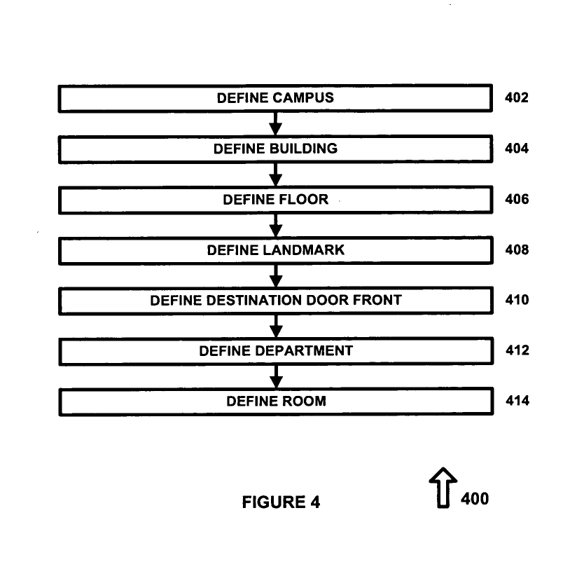

FIG. 4 is a diagram of a method for a zone of ownership hierarchy construction in accordance with an exemplary embodiment of the present invention. Method 400 allows the use of relational wayfinding constructs to organize features of a physical environment into structured relational data. In one exemplary embodiment, the major wayfinding constructs are landmarks and zones of ownership. The notion of a zone of ownership is a creation of a hierarchical relationship between destinations and the landmark that “owns” them. The structured data is the foundation of the system and allows manipulation of one piece of the system and the ability to cascade those changes using various workflows to protect and extend the wayfinding logic of the system as the physical environment changes. In one exemplary embodiment, the manipulation of one piece of the system would involve moving a destination, closing an elevator or adding a building. Additionally, workflow would consist of updating signs, editing pathways, adding landmarks and adding destinations.

Method 400 begins at 402 where the broadest zone of ownership category exists. Definition of the campus. In one exemplary embodiment, the campus is an Austin automotive plant. Additionally, the campus can be any facility, collection of buildings, or work area. The method then proceeds to 404.

At 404, the scope of the zone of ownership is narrowed to define the building. In one exemplary embodiment, the building is Bldg. 75, the final assembly building of the Austin automotive plant. The method then proceeds to 406.

At 406, definition of the floor further limits the scope of the zone of ownership concept. In one exemplary embodiment, the floor is 1st Floor, Bldg. 75, Austin automotive plant. The method then proceeds to 408.

At 408, the definition of a landmark is included in the concept of the zone of ownership hierarchy. In one exemplary embodiment, the landmark is Bay 7, 1st Floor, Bldg. 75, Austin automotive plant. The method then proceeds to 410.

At 410, the definition of the destination door front is included to further narrow the scope of the zone of ownership logic narrowing. In one exemplary embodiment, the door front is automotive interiors, Bay 7, 1st Floor, Bldg. 75, Austin automotive plant. The method then proceeds to 412.

At 412, the department within the door front is defined and at even finer resolution for the zone of ownership. In one exemplary embodiment, the door front is automotive seats, automotive interiors, Bay 7, 1st Floor, Bldg. 75, Austin automotive plant. The method then proceeds to 414.

At 414, the definition of the room is the lowest level for the zone of ownership logic. In one exemplary embodiment, the room is receiving, automotive seats, automotive interiors, Bay 7, 1st Floor, Bldg. 75, Austin automotive plant, completing the hierarchical description of the location.

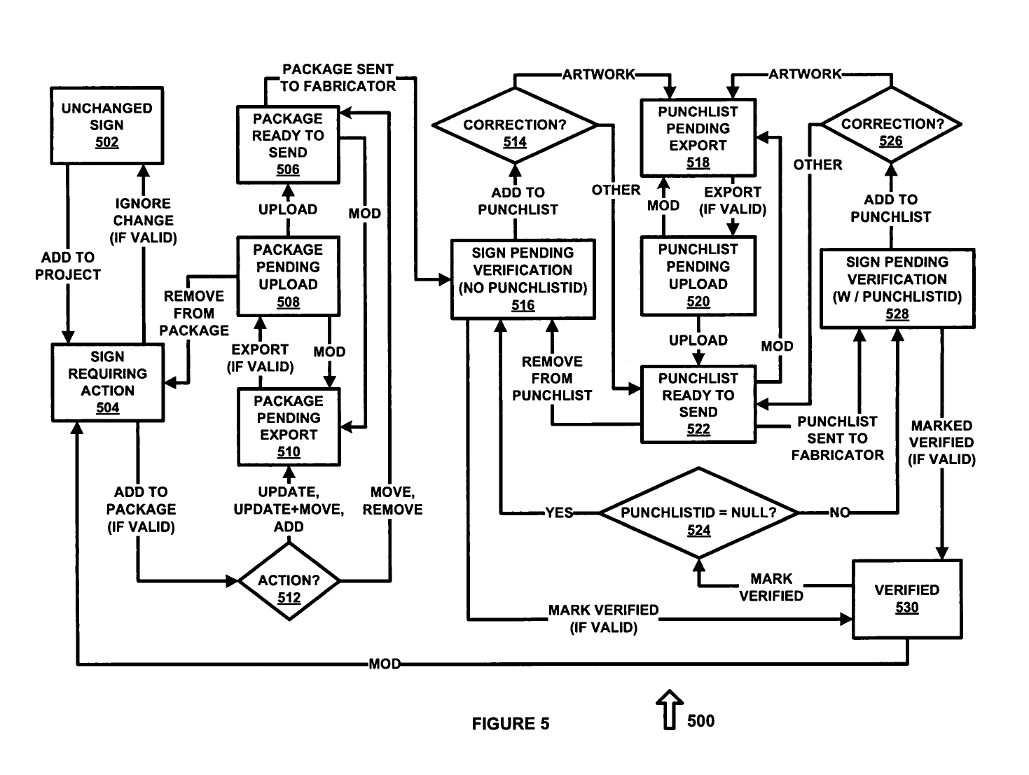

FIG. 5 is a diagram of a signage generation method in accordance with an exemplary embodiment of a present invention. The method 500 allows the addition, deletion and updating of physical signage and illustrates the life cycle of a sign.

Method 500 begins at 502 which is an unchanged sign that requires no action. If a sign is added to a project, the method then proceeds to 504.

At 504, sign requiring action, the sign is pending export. The method then proceeds to 502 if the change or addition is to be ignored. The method then proceeds to 512 if the sign is to be added to a package.

At 512, there is shown a decision block regarding the action to be taken regarding the sign. The method proceeds to 510 if the sign is to be updated and moved or added. The method proceeds to 506 if the sign is to be moved or removed.

At 510, the sign package is pending export. When the sign package is exported, the method proceeds to 508.

At 508, the sign package status is pending. If the sign package is uploaded, the method proceeds to 506. If the sign package is modified, the method proceeds to 510.

At 506, the sign package is ready to send. The method then proceeds to 516 if the sign package is sent to the fabricator. The method proceeds to 510 if the sign package is modified.

At 516, the sign is pending verification with PUNCHLISTID equal to Null. The method proceeds to 530 if the sign is marked “verified.” The method proceeds to 514 if the sign is added to a punchlist.

At 514, there is shown a correction decision block. If there is a correction to the sign artwork, the method proceeds to 518. The method proceeds to 522 if there is some other sign correction to be made.

At 518, the sign punchlist is pending export. The method then proceeds to 520.

At 520, the sign punchlist is pending upload. The method proceeds to 518 if there is a sign punchlist modification. The method proceeds to 522 if the sign punchlist is uploaded.

At 522, the sign punchlist is ready to be sent. The method proceeds to 518 if there is a modification. The method proceeds to 516 if the sign is to be removed from the punchlist. The method proceeds to 528 if the sign punchlist is sent to the fabricator.

At 528, the sign is pending verification with a PUNCHLISTID not equal to Null. The method proceeds to 530 if the sign is marked “verified.” The method proceeds to 526 if it is added to a punchlist.

At 526, there is shown a correction decision block. If the correction is to the artwork, the method proceeds to 518. The method proceeds to 522 if there is another form of correction.

At 530, the sign is verified. The method proceeds to 524 if the sign is marked as “verified.” The method proceeds to 504 if the sign is modified.

At 524, there is shown a PUNCHLISTID equal to Null decision block. The method proceeds to 528 if the PUNCHLISTID is not equal to Null. The method proceeds to 516 if the PUNCHLISTID is equal to null. In one exemplary embodiment, a facility manager makes a change to a sign, prepares packages to be sent to an in-house sign shop for new sign creation, prints a punchlist and verifies that the signs have been built and installed properly.

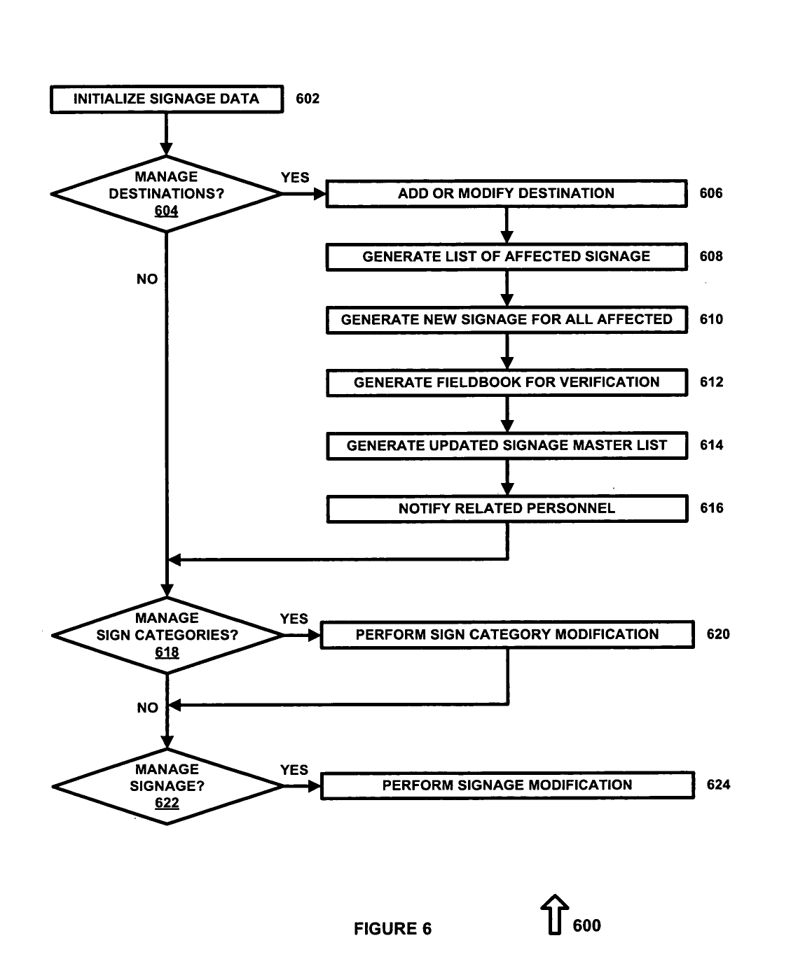

FIG. 6 is a diagram of a signage method in accordance with an exemplary embodiment of the present invention. Method 600 allows for a plurality of signage management functions to be executed. Method 600 begins at 602 where the signage data is initialized. The method then proceeds to 604.

At 604, there is shown a manage destinations decision block. If the destinations are to be managed, the method then proceeds to 606. If the destinations are not to be managed, the method then proceeds to 618.

At 606, the destination is modified or a destination is added. The method then proceeds to 608.

At 608, a list of affected signage is generated for the added or modified destination. The method then proceeds to 610.

At 610, new signage for all affected signs is generated. The method then proceeds to 612.

At 612, a field book for verification of the sign placement and installation is generated. The method then proceeds to 614.

At 614, an updated signage master list is generated. The method then proceeds to 616.

At 616, the related personnel are notified. In one exemplary embodiment, the central auditorium has been renamed “The Morrison Auditorium” to recognize a donor. The facilities manager changes the name in the managed destinations module, automatically generates a list of all signage effected by this change, prepares packages to be sent to an in-house sign shop and/or fabricator to create the new signs, prints a field book for verification that the signs have been built and installed properly and generates an updated master list of the destinations and sends it to the marketing department for their use in communication materials. It is important to know that the name change only had to be made once and the management tool managed all the cascading changes. The method then proceeds to 618.

At 618, there is shown a manage sign categories decision block. If the sign categories are to be managed, the method then proceeds to 620. If the sign categories are not to be managed, the method then proceeds to 622.

At 620, sign category modification is performed. In one exemplary embodiment, a facility manager has noticed that people are getting lost on their way back to the parking garage. To make matters more confusing, there are two entrances to the garage. She determines that all relevant directional signs should include directions to the garage entrances. She edits the directional sign type, determines that the garage be listed last after all the interior destination generates a list of signage effected by this changes, exports new message schedules for the effected signs, prepares packages to be sent to an in-house sign shop to create the new signs and prints a field book and verifies the signs have been built and installed properly. Since she has made a systematic change, all fuiture directional signs of this type will be programmed to contain garage entrances. The method then proceeds to 622.

At 622, there is shown a signage managed decision block. If the signage is to be managed, the method then proceeds to 624.

At 624, signage modification is performed. In one exemplary embodiment, the Admissions Office of an urban university is moving from a small stand-alone building to a new addition to the Student Union. The facility manager will create one project named Admissions Office moved and enter the target end date, make the required changes on the relevant floor plans, create a package of exterior signs so that he can receive bits from fabricators on that job while the sign shop takes care of the interior signs, print out a field book and verify that they were installed properly, coordinate with his peers in the graphics department to update all maps, visitors' guides and the website.

Although exemplary embodiments of a system and method of the present invention have been described in detail herein, those skilled in the art will also recognize that various substitutions and modifications can be made to the systems and methods without departing from the scope and spirit of the appended claims. It is therefore the intention that the appended claims be interpreted as broadly as possible in view of the prior art to include all such variations and modifications.

What is claimed is:

1. A system for generating directions to destinations without an associated street address comprising:
relational wayfinding logic receiving origination identification data associated with an origination and destination identification data associated with a destination and generating a route between the origination and the destination;
zone of ownership logic receiving the route and generating one or more landmarks along the route using a zone of ownership associated with each of the one or more landmarks; and
wherein an observer can follow the one or more landmarks from the origination to the destination.

2. The relational wayfinding system of claim 1 further comprising a landmark system generating a plurality of landmarks and receiving a user selection to generate the destination identification data.

3. The relational wayfinding system of claim 1 further comprising a thoroughfares system storing a plurality of thoroughfares between a plurality of predefined originations and a plurality of predefined destinations.

4. A method for generating directions to locations without an associated street address comprising:
receiving an origination;
receiving a user-selected destination;
retrieving one or more landmarks between the origination and the user selected destination; and
generating an ordered list of the one or more landmarks.

5. The method of claim 4 wherein each of the landmarks comprises unique coordinates.

6. The method of claim 4 wherein each of the landmarks is isolated from the remaining landmarks.

7. The method of claim 4 wherein generating the ordered list of the one or more landmarks comprises retrieving a predetermined ordered list from memory.

8. The method of claim 4 wherein retrieving the one or more landmarks between the origination and the user-selected destination comprises:
determining a route between the origination and the destination; and
identifying each of the one or more landmarks by an associated zone of control for each of the plurality landmarks that overlaps the route.

9. The method of claim 4 wherein receiving the user-selected destination comprises:
generating a list of destinations; and
receiving the user-selected destination from the list of destinations.

10. A method for providing directions within a facility to locations without an associated street address comprising:
receiving a record identifier associated with a user;
receiving an origination associated with the user;
determining a destination for the user based on the record identifier; and
generating an ordered list of one or more discrete landmarks, wherein each landmark lies on a route between the origination and the destination; and
generating associated instructions to guide the user from each landmark to the destination.

11. The method of claim 10 wherein determining the destination for the user based on the record identifier comprises:
identifying an appointment associated with the record identifier;
identifying a location without an associated street address based on the appointment; and
associating the location with the destination.

12. The method of claim 10 wherein generating the ordered list of one or more discrete landmarks comprises retrieving a predetermined ordered list from memory.
